(19) United States
(12) Patent Application Publication
(10) Pub. No.: US 2008/0195535 A1
(43) Pub. Date: Aug. 14, 2008

(54) Method for Flexibly Configuring Charging Modes in Ims Systems

(75) Inventor: Sheng Liu, Guangdong Province (CN)

Correspondence Address: CALFEE HALTER & GRISWOLD, LLP, 800 SUPERIOR AVENUE, SUITE 1400, CLEVELAND, OH, 44114, US

(73) Assignee: UTSTARCOM TELECOM CO., LTD., Hangzhou (CN)

(21) Appl. No.: 11/912,907

(22) PCT Filed: Apr. 29, 2005
(86) PCT No.: PCT/CN05/00600

§ 371 Date: Oct. 29, 2007

(51) Int. Cl. G06Q 20/00

(52) U.S. Cl. 705/39

(57) ABSTRACT

The present invention provides a method and system for flexibly configuring charging information in an Internet protocol multimedia sub-system. According to the invention, charging mode information of respective application servers involved in a user service is stored in the home subscriber server, the home subscriber server sends charging function address information and charging mode information to a service call state control function unit, the service call state control function unit determines, based on the received charging function address information and the charging mode information, the charging function addresses for the respective application servers, and forwards corresponding charging function address information to the respective application servers, respectively.

### TECHNICAL FIELD

The present invention relates to a charging control technique in an Internet protocol multimedia sub-system (IMS), in particular to a method and system for flexibly configuring real-time charging and non-real-time charging for different applications.

### BACKGROUND ART

The Internet protocol multimedia sub-system (IMS) is an all-IP-based network for providing Internet protocol multimedia service introduced in the fifth edition of 3GPP (Third Generation Partnership Project), and further improved and enhanced in the sixth edition. The typical characteristics thereof are to perform the call control of multimedia session of end to end Internet protocol by means of signaling SIP (Session Initiation Protocol) at the Internet protocol application level, and to provide flexible and extendible service configuration.

According to specifications TS32.240 and TS32.260 of 3GPP, IMS system provides two charging modes, which are off-line charging mode operating in a non-real-time fashion and on-line charging mode operating on a real-time fashion. In the conventional IMS system, application server (AS) obtains the charging and service related information from the home subscriber server (HSS) in such a way that HSS transmits the information to the service call state control function unit (S-CSCF) via Cx interface, then S-CSCF transmits the information via the ISC interface to AS. In this way, the Cx interface uses Diameter protocol for communication, and the ISC interface between S-CSCF and AS uses the SIP protocol for communication. Detailed descriptions of Diameter protocol and SIP protocol can be found in the specifications of RFC3588 and RFC3261, etc. of IETF (Internet Engineering Task Force).

According to specification TS29.229 of 3GPP, the charging information at the Cx interface is transmitted to S-CSCF by HSS through diameter commands such as Server-Assignment-Answer (SAA), Push-profile-Request (PPR), etc., wherein SAA command is a response made by HSS to the Assignment-Request (SAR) command initiated by S-CSCF during the registration of UE (user equipment), and PPR is a command of updating the user subscription information initiated by HSS voluntarily to S-CSCF when the user subscription information changes after the successful registration of UE. Specifically, the charging information is provided by the “Grouped” type of AVP (attribute value pair) “Charging-Information” carried by the commands such as SAA and PPR. The AVP further comprises AVPs of “Primary-Event-Charging-Function-Name”, “Secondary-Event-Charging-Function-Name”, “Primary-Charging-Collection-Function-Name”, and “Secondary-Charging-Collection-Function-Name”, with the type of “DiameterURI”, which respectively correspond to the addresses of the primary ECF, secondary ECF, primary CCF and secondary CCF. The secondary ECF and the secondary CCF are provided for supporting the redundant configuration of the charging system to ensure high reliability of the charging.

FIGS. 4 and 5 respectively show the message formats of Diameter commands Server-Assignment-Answer (SAA) and Push-Profile-Request (PPR) defined by TS29.229 represented by the syntax of ABNF (Augmented Backus-Naur Form). As for the ABNF syntax and the definitions and usages of the AVPs shown in the figures, please refer to documents relating to the IETF specifications RFC 2234, RFC3588 and 3GPP specifications TS29.229 and TS29.228, wherein the AVP “User-Data” with the type of “OctetString” is the user service information described in the XML (Extensible Makeup Language) format, and the AVP “Charging-Information” with the type of “Grouped” provides the charging function address related to the user subscription service. According to the 3GPP specification TS29.228, when the above commands include AVP “User-Data”, AVP “Charging-Information” should also present, and at least the address of primary CCF must be provided.

FIG. 6 further shows the UML (Unified Modeling Language) model of the user service information defined by TS29.228 (as for UML, reference can be made to http://www.omg.org/uml), and the attribute of the class is not shown in the figure for simplicity. It can be seen that the service information of a user is represented by the “IMS Subscription” class. An example of the “IMS Subscription” class is formed of one or more “Service profile” classes, while an example of the “Service Profile” class is formed of one or more examples of “Public Identification” class, zero or one example of “Core Network Service Authorization” class, zero or multiple examples of “Initial Filter Criteria” class, and zero or multiple examples of “Shared iFC Set” class.

FIG. 7 further shows the UML model of the “Initial Filter Criteria” class. It can be seen that an example of the “Initial Filter Criteria” class is formed of zero or one example of the “Trigger Point” class and one example of the “Application Server” class, while an example of “Trigger Point” class is formed of one or more examples of “Service Point Trigger” class, and an example of “Application Server” class is formed of zero or one example of “Service Information” class. The “Application Server” class specifies that when the service trigger point in the initial filter criteria (iFC) is triggered, the AS of the corresponding service is provided. In the prior art, the “Application Server class” has two attributes, i.e. ServerName and DefaultHandling, wherein ServerName provides the SIP URL (Uniform Resource Locator) of the application server and DefaultHandling is the enumeration type with value “SESSION_CONTINUED” or “SESSION_TERMINATED”, indicating whether the SIP session is continued or terminated when the application server cannot be connected.

As described previously, after obtaining the charging information (i.e. the charging function address) through the Cx interface, the S-CSCF transmits the information to AS via the ISC interface. The special SIP message head P-Charging-Function-Addressees defined according to IETF specifications RFC3455 and 3GPP can be used to this end. According to the 3GPP specification TS24.229, during the UE registration, when S-CSCF obtains, via the Cs interface, the user subscription information including the charging information, it will initiate a third party registration to the respective application servers matching the initial filter criteria (iFC) provided by the user subscription information, while the charging function address of the AS is carried by the message head P-Charging-Function-Addresses of the third party registered SIP message. In addition, after the SIP session initial request or independent transaction request and the 1xx or 2xx response to the requests are received by the S-CSCF, the charging function address of corresponding AS is carried by the SIP message head P-Charging-Function-Addresses too before being transferred to the AS.

According to the 3GPP specifications TS32.225 and TS32.260, AS can determine which charging mode it will use, and such determination is made from the SIP message head P-Charging-Function-Addresses of the ISC interface, that is, if AS receives only the address of CCF but not the address of ECF, an off-line charging is performed through the Rf interface; if AS receives only the address of ECF, on-line charging is performed through the Ro interface; if AS receives both the address of the ECF and the address of CCF, charging is performed simultaneously through the two interfaces.

However, the existing specifications of 3GPP do not specify whether it is transmitting the charging function address obtained by S-CSCF via the Cx interface AVP “Charging-Information” to the respective AS via the ISC interface without any change or it is selectively providing the relevant charging function address to the AS via the ISC interface with respect to different AS. Since the user service data obtained by the S-CSCF from the Cx interface does not specify the charging mode used by the application subscribed by the user, the prior art actually only allows using of the former mode, that is, the charging function addresses transmitted by the S-CSCF to the respective AS through the ISC interface are completely the same; so for a certain UE, all the subscription services should use the same charging mode.

Furthermore, as described above, S-CSCF also supports the two modes of off-line charging and on-line charging. But the prior art does not provide the indication information for the charging mode used by S-CSCF itself, so when the Cx interface AVP “Charging-Information” includes both CCF and ECF, S-CSCF cannot determine which charging mode should be used. Since the on-line charging of S-CSCF is implemented through IMS-GWF (IMS Gateway Function Unit), and IMS-GWF is also an application server (e.g. IMS-GWF can be considered as an application server of IMS pre-paid service) for S-CSCF, this problem is the same as the above mentioned one.

As an alternative solution, the charging and service related information can also be transmitted by HSS to AS through the Sh interface directly connected to AS. According to the 3GPP specification TS29.329, the charging information obtained from Sh interface is transmitted from HSS to AS through Diameter commands such as User-Data-Answer (UDA), Push-Notification-Request (PNR). Wherein if the AVP “Data-Reference” carried by the User-Data-Request (UDR) command initiated by AS specifies that the requested user data includes the charging information, then HSS will provide the charging information in the AVP “User-Data” that responds to command UDA. In addition, if the AVP “Data-Reference” carried by the Subscriber-Notifications-Request (SNR) command initiated by AS specifies that the subscribed user data includes the charging information, then HSS will provide the charging information in the AVP “User-Data” of PNR command when the user's subscription information changes. Although the AVP “User-Data” of Sh interface is described by the XML (Extensible Markup Language), the charging function address information included therein is the same as the charging function address information provided by the AVP of Diameter through Cx interface in terms of the data structure and the usage.

However, there are the following problems and restrictions in providing different charging function addresses to the AS through Sh interface in the prior art:

According to the 3GPP specifications TS24.229 and TS29.328, the premise for an AS obtaining the charging function address from the Sh interface is that there is an Sh interface between AS and HSS, and the AS and the S-CSCF connected thereto are within the same trust field. Thus for some applications, such as PoC (PTT over Cellular) service, that do not provide the Sh interface, or for some applications that are provided by the third party service provider, AS cannot obtain the corresponding charging function address from the Sh interface.

As stated in the 3GPP specifications TS24.229 and TS29.328, the method of AS obtaining the charging function address from the Sh interface is not used as an equivalence to the method of obtaining the charging function address from ISC, interface, but it is only used in some special cases, for example, the charging function address is obtained through the Sh interface only when the charging function address is needed before the AS receives the third party registration from the ISC interface.

According to the 3GPP specifications TS23.218 and TS29.328, when the charging function address received from ISC interface is not consistent with that received from Sh interface and thus causing conflict, the charging function address received from ISC interface has priority, it means that the charging function address received from ISC interface is used and the charging function address received from Sh interface is ignored. Therefore, even if AS can obtain the corresponding charging function address from Sh interface, as mentioned above, the charging function addresses sent by S-CSCF to the respective AS through ISC interface are all identical in the prior art, so it is still impossible to achieve the function of different AS obtaining different charging function addresses.

In the prior art, AS statically pre-configures the ECF or CCF address locally, so that AS uses a different charging function address setting from the IMS system. But such static configuration will result in that all the users use the same charging mode, so it is impossible to flexibly use different charging modes for different users.

With respect to the above problems, the present invention provides a simple but effective way to implement flexible configuration of the modes of real-time charging and non-real-time charging for different applications in the IMS system.

### SUMMARY OF THE INVENTION

It is a object of the present invention to provide charging mode control information for respective ASs involved in an user subscription service from HSS to the S-CSCF via the Cx interface, and to transmit corresponding charging mode information to the respective ASs after the S-CSCP judging the information, thereby solving the problem that the existing IMS system cannot flexibly configure the real-time or non-real-time charging mode for different applications.

According to one aspect of the present invention, a method of configuring charging information in an Internet protocol multimedia sub-system including a home subscriber server, a service call state control function unit and application servers is provided, which is characterized by comprising following steps:

storing charging mode information of the respective application servers involved in an user service in the home subscriber server;

sending charging function address information and the charging mode information to the service call state control function unit by the home subscriber server;

determining at the service call state control function unit, based on the received charging function address information and the charging mode information, charging function addresses for the respective application servers, and forwarding corresponding charging function address information to the respective application servers, respectively.

Preferably, the step of storing charging mode information of the respective application servers involved in an user service in the home subscriber server is performed by adding the charging mode information for the respective application servers to the data representing user subscription information.

More preferably, an attribute of charging mode information is added to an “Application Server” class of the Unified Modeling Language model of the data representing the user subscription information, whose values include a value corresponding to the on-line charging mode and a value corresponding to the off-line charging mode.

More preferably, the added attribute is an attribute “ChargingType” with the type of “enumerated”, whose values are “ONLINE-CHARGING” corresponding to the on-line charging mode, and “OFFLINE-CHARGING” corresponding to the value of the off-line charging mode.

Preferably, the charging mode information is carried by an attribute value pair “User-Data” in the interface protocol between the home subscriber server and the service call state control function unit, thereby transmitting the charging mode information from the home subscriber server to the service call state control function unit.

More preferably, the charging mode information is included in user service information provided by the attribute value pair “User-Data” and described by the Extensible Markup Language.

Preferably, an attribute value pair specifying the charging mode for the corresponding application server is added to the interface protocol between the home subscriber server and the service call state control function unit, thereby transmitting the charging mode information from the home subscriber server to the service call state control function unit.

More preferably, a byte in the data field of the newly defined attribute value pair is corresponding to the charging mode for the application server, wherein “00000000” represents on-line charging, and “00000001” represents off-line charging.

More preferably, in the data field of the newly defined attribute value pair, the sequence of the application servers corresponding to each of the bytes is the same as the sequence of appearance of the application servers in the user service information data represented by the Extensible Markup Language in the attribute value pair “User-Data”.

Preferably, the service call state control function unit determines the charging function addresses for respective application servers according to the received charging mode information for the respective application servers and the charging function address provided in the attribute value pair “Charging-Information”, and transmits the corresponding charging addresses to the respective application servers, respectively.

More preferably, when the charging function address provided by the received attribute value pair “Charging-Information” includes at least one ECF and at least one CCF, if the specified charging mode for an application server is on-line charging, the charging function addresses sent to the application server include at least all the ECF addresses provided by the attribute value pair “Charging-Information”, if the specified charging mode for the application server is off-line charging, the charging function addresses sent to the application server are all the CCF addresses provided by the attribute value pair “Charging-Information”; and if the charging mode for the application server is not specified, the charging function addresses sent to the application server are all the addressed provided by the attribute value pair “Charging-Information”.

More preferably, when the charging function addresses provided by the attribute value pair “Charging-Information” include only CCF, the charging function addresses sent to the application server are all the addresses provided in the attribute value pair “Charging-Information”.

According to another aspect of the present invention, an Internet protocol multimedia sub-system in which the charging information can be flexibly configured is provided, the Internet protocol multimedia sub-system including a home subscriber server, a service call state control function unit, and application servers, characterized in that

the home subscriber server is used for storing charging mode information of the application servers involved in an user service and for transmitting the charging function address information and the charging mode information to the service call state control function unit;

the service call state control function unit is used for determining charging function address for respective application servers based on the received charging function address information and the charging mode information, and for forwarding corresponding charging function address information to the respective application servers, respectively.

Preferably, the data representing user subscription information stored in the home subscriber server includes the charging mode information for each of the application servers.

More preferably, an “Application Server” class of the Unified Modeling Language model of the data representing the user subscription information includes an attribute of the charging mode information, whose values includes a value corresponding to the on-line charging mode gad a value corresponding to the off-line charging mode.

More preferably, the attribute of the charging mode information is an attribute “ChargingType” with the type of “enumerated”, whose values are “ONLINE-CHARGING” corresponding to the on-line charging mode, and “OFFLINE-CHARGING” corresponding to the value of the off-line charging mode.

Preferably, the charging mode information is carried by an attribute value pair “User-Data” in the interface protocol between the home subscriber server and the service call state control function unit, thereby transmitting the charging mode information from the home subscriber server to the service call state control function unit.

More preferably, the charging mode information is included in user service information provided by the attribute value pair “User-Data” and described by the Extensible Markup Language.

Preferably, the interface protocol between the home subscriber server and the service call state control function unit includes an attribute value pair for specifying the charging mode for the corresponding application server to transmit the charging mode information from the home subscriber server to the service call state control function unit.

More preferably, a byte in the data field of the attribute value pair is corresponding to the charging mode for the application server, wherein “00000000” represents on-line charging, and “00000001” represents off-line charging.

More preferably, in the data field of the attribute value pair, the sequence of the application servers corresponding to each of the bytes is the same as the sequence of appearance of the application servers in the user service information data represented by the Extensible Markup Language in the attribute value pair “User-Data”.

Preferably, the service call state control function unit is configured to determine the charging function addresses for respective application servers according to the received charging mode information for the respective application servers and the charging function address provided in the attribute value pair “Charging-Information”, and to transmit the Corresponding charging addresses to the respective application servers, respectively.

More preferably, when the charging function address provided in the attribute value pair “Charging-Information” received by the service call state control function unit includes at least one ECF and at least one CCF, if the specified charging mode for an, application server is on-line charging, the charging function addresses sent by the service call state control function unit to the application server include at least all the ECF addresses provided by the attribute value pair “Charging-Information”; if the specified charging mode for the application server is off-line charging, the charging function addresses sent by the service call state control function unit to the application server are all the CCF addresses provided by the attribute value pair “Charging-Information” and if the charging mode for the application server is not specified, the charging function addresses sent by the service call state control function unit to the application server are all the addresses provided by the attribute value pair “Charging-information”.

More preferably, when the charging function addresses provided by the attribute value pair “Charging-Information” include only CCF, the charging function addresses sent to the application server are all the addresses provided in the attribute value pair “Charging-Information”.

By means of the method and system of the present invention, flexible configuration of the charging mode for different applications is realized in the IMS system. In fact, for some specific applications, independent and controllable charging mode will facilitate the popularization and implementation of the service. For example, a specific application (e.g. PoC service) is provided by a third party operator independently, then although a user subscribes for a common non-real-time charging mode in the IMS home network operator, such as typically paying the IMS communication fees every month by transferring account, according to the call record, from a bank account authorized by, the user if this user, is allowed to buy the pre-paid card for the specific application from the third party operator that provides the specific service such as the PoC service, i.e. if the user is allowed for access to the service by pre-payment, it will help the wide implementation of IMS and the relevant applications. Even if the IMS fundamental network operator is the same one as the operator that provides the specific services such as the PoC service, this function for flexible configuring the charging mode will still help the operator in popularizing the specific application with high added-value.

### DESCRIPTION OF THE DRAWINGS

The present invention will be described below with reference to the figures and in conjunction with the embodiments of the invention by way of examples, thus the above characteristics and advantages of the invention will be understood better. In the figures:

FIG. 1 is a schematic drawing of the structure of the IMS system;

FIG. 2 is a schematic drawing of the structure of the IMS charging system;

FIG. 3 is a schematic drawing of the structure of the OCS system;

FIG. 4 is a schematic drawing of the message format of SAA command of the Cx interface in the prior art;

FIG. 5 is a schematic drawing of the message format of PPR command of the Cx interface in the prior art;

FIG. 6 is a schematic drawing of the UML model of the user service information;

FIG. 7 is a schematic drawing of the UML model of the iFC class in the prior art;

FIG. 8 is a schematic drawing of the UML model of the iFC class in the present invention;

FIG. 9 a schematic drawing of the AVP “Application-Server-Charging-Type” newly defined in the present invention;

FIG. 10 is a schematic drawing of the message format of SAA command the Cx interface in the present invention;

FIG. 11 is a schematic drawing of the message format of PPR command of the Cx interface in the present invention;

FIG. 12 shows the control of the AS charging mode during the UE registration.

### PREFERRED EMBODIMENTS

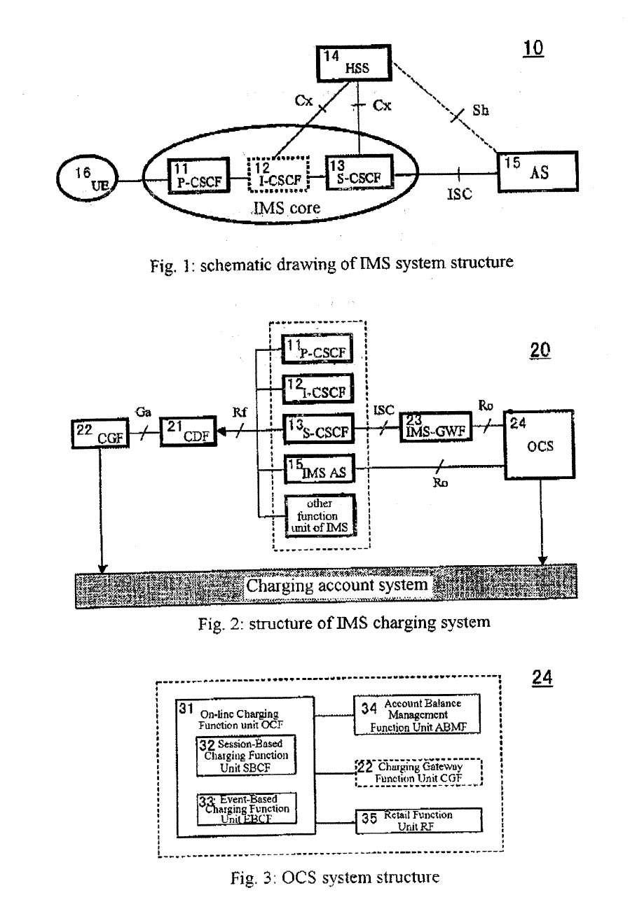

FIG. 1 shows the structure of the IMS system of the present invention, the IMS system generally is represented by reference number 10. The IMS system 10 comprises a P-CSCF (Proxy Call State Control Function Unit) 11 used as the IMS core, an I-CSCF 12 (Inquire Call State Control Function Unit), a S-CSCF (Service Call State Control Function Unit) 13, a HSS (Home subscriber server) 14, and a AS (Application Server) 15. Wherein, the P-CSCF 11 is an initial access point for the UE (User Equipment) 16 accessing the IMS via SIP (Session Initiation protocol) signaling, which mainly performs the functions of SIP message compression/decompression, SIP message forwarding, etc.; S-CSCF 13 is the session control and service excitation function unit of the home network of the UE 16, which is used for user authentication and authorization, maintaining the SIP registration information of the user, session control and service triggering, and providing the charging information; I-CSCF 12 is mainly used for shielding the topology structure of the operator network, allocating S-CSCF 13 and for routing of the SIP message between the P-CSCF 11 and the S-CSCF 13 connected to the UE 16; AS 15 is a function unit used for implementing various application services, which mainly provides the service logic and service control of the application and provides the charging information of the corresponding service to the charging system; HSS 14 is the user configuration database server, which is used for storing data like the location information of the user, various subscription information of the user, and the charging mode information corresponding to the respective AS 15. The interface between S-CSCF 13/1-CSCF 12 and HSS 14 is Cx interface, and the interface between S-CSCF 13 and AS 15 is ISC interface.

FIG. 2 shows the structure of the charging system 20 of the IMS system 10 according to the present invention. Wherein CDF (Charging Data Function Unit) 21 and CGF (Charging Gateway Function Unit) 22 are used for off-line charging, wherein CDF 21 generates the CDR (Charging Data Record) from the charging event data provided by respective network elements through the Rf interface, and CGF 22 is used for generating the CDR file from the CDR provided by CDF 21 through Ga interface and finally transmitting it to the charging account system. OCS (on-line charging system) 24 is used for on-line real-time charging. The IMS application server is connected to OCS 24 via interface Ro, and S-CSCF 13 is connected to OCS 24 via IMS-GWF (IMS gateway function unit) 23. The interface between S-CSCF 13 and IMS-GWF 23 is an ISC interface, and the interface between IMS-GWF 23 and OCS 24 is a Ro interface. Wherein the Ro and Rf interfaces use the Diameter protocol for communication.

The pre-paid service in the IMS system 10 is typical implemented by OCS 24. As shown in FIG. 3, OCS 24 is comprised of OCF (On-line Charging Function Unit) 31, ABMF (Account Balance Management Function Unit) 34, RF (Retail Function Unit) 35, and an optional CGF (Charging Gateway Function Unit) 22, wherein OCF 31 is formed of the two functional modules of the session based charging function unit (SBCF) and the event based charging function unit (EBCF). OCS 24 can perform session based or event based on-line charging and credit control, and can control the availability of the application services to the user on the service level, for example, it can grant or reject user to use specific services in the network.

According to the 3GPP specification TS32.240, for the purposes such as phonecall fees tracking and account settlement between operators, it is allowed to generate CDR while performing real-time charging. Two methods can be used to implement this, one is performing on-line and off-line charging simultaneously, and the other is directly performing the function of CDF 21 in OCS 24 or performing the functions of CDF 21, and CGF 22 simultaneously, thereby allowing transmitting the CDR or CDR file generated by OCS 24 to CGF 22 or the charging account system.

According to a preferred embodiment of the present invention, HSS 14 is made to store the charging mode information corresponding to the respective AS 15 by adding the charging mode information corresponding to the respective application servers to the, data representing the user subscription information. FIG. 8 shows the Unified Modeling Language model of the data representing the user subscription information. As mentioned previously, in the prior art, an example of “Initial Filter Criteria” class is formed of zero or one example of “Trigger Point” class and one example of “Application Server” class. The “Application Server” has two attributes, i.e. the ServerName attribute providing the Uniform Resource Locator of the application server and the DefaultHandling attribute indicating whether the SIP session continues or terminates when the application server cannot be connected. According to the present invention, in order to add the charging mode information for the application server to the UML model, a new attribute “ChargingType”-“enumerated” is added to the attribute of “Application Server” class for specifying the charging mode used by the application server. The values of the newly added attribute are “ONLINE-CHARGING”, “OFFLINE-CHARGING” and “UNDEFINED”, wherein the former two values are respectively corresponding to the on-line and off-line charging mode, and “UNDEFINED” indicates that there is no specific definition for the charging mode of the AS. Of course, those skilled in the art can also understand that the newly added type is not limited to “ChargingType”, and the values thereof are not limited to “ONLINE-CHARGING”, “OFFLINE-CHARGING” and “UNDEFINED”, but it is possible to use other attributes and values thereof that can differentiate the real-time charging from the non-real-time charging.

After the data structure is modified, the charging mode information is sent to S-CSCF 13 through the attribute value pair “User-Data” in the Cx interface. Since the attribute value, pair “User-Data” in the Cx interface, uses the XML format to represent the user service information data, the characteristic of XML language using text coding with the good extensibility makes it possible for the embodiment to neither modify or extend the Diameter command of the Cx interface, nor add AVP item, so it has better backward compatibility.

In addition, as shown in FIG. 6, an example of “Service Profile” class also includes zero or multiple examples of “Shared iFC Set” class. According to TS29. 228, this class is represented only by an attribute “Identifier” with the type of integer (not shown in the figure), for pointing to the set of initial filtering criteria (iFC) that is managed and stored locally and shared by a plurality of “Service profile” in S-CSCF 13. Since the iFcs in the shared iFC set that is managed and stored locally in S-CSCF 13 still have the same data structures as the above-mentioned “Initial Filter Criteria” class, according to the present invention, the same method can be used, that is, adding the data items indicating the charging modes used by the application servers to the data structures of the shared iFC set that is managed and stored locally in S-CSCF 13.

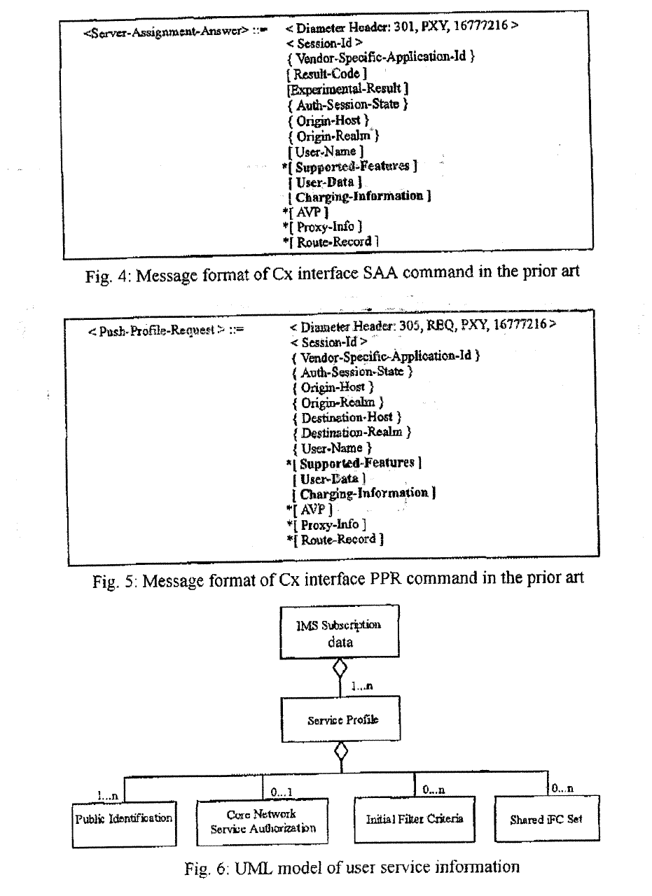

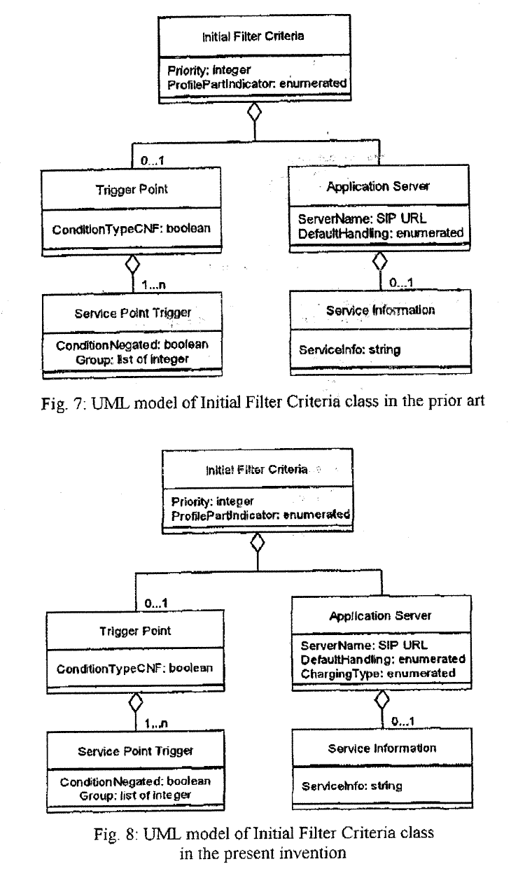

In order to implement flexible configuration of the respective charging modes for different applications in the IMS system 10, according to the present invention, as an alternative for the solution of sending the charging mode to the S-CSCF 13 through the attribute value pair “User-Data” in the Cx interface, the new attribute value pair can be extended in the Cx interface to specify the charging modes for the application servers concerned in the subscribed Service Profiles of the user. As described above with reference to FIGS. 4 and 5, SAA and PPR commands in the prior art include AVP “User-Data” with the type of “OctetString”, i.e. user service information described by XML format, and AVP “Charging-Information” with the type of “Grouped” for providing the charging, function address relevant to the user subscription service. The present invention includes but is not limited to extending an AVP “Application-Server-Charging-Type” with the type of “OctetString” for specifying the charging modes for the application servers concerned in the subscribed Service Profiles of the user.

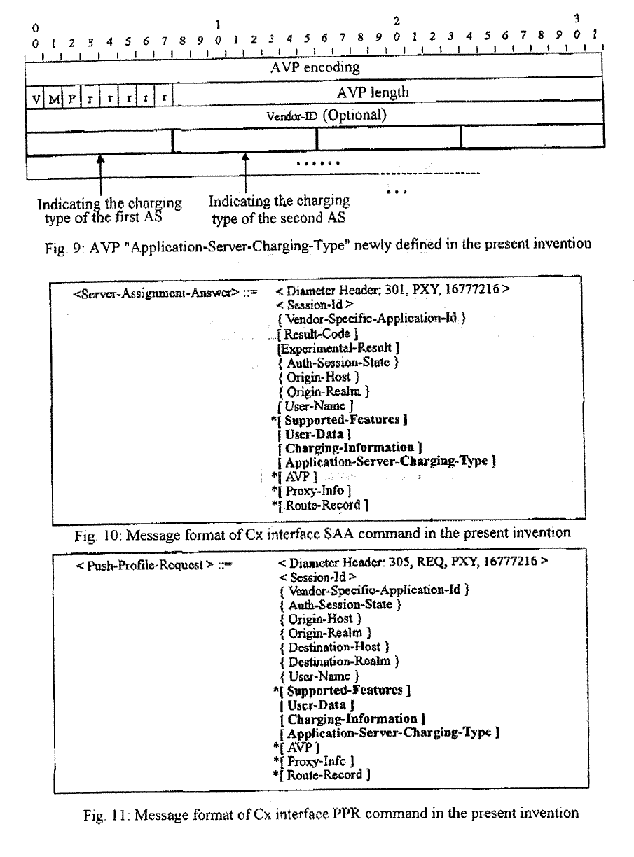

FIG. 9 shows the AVP encoding structure and the specific usage. Definitions of fields in a head of AVP can be found in IETF specification RFC3588, wherein according to 3GPP specification TS29.230, 632 to 699 in the AVP encoding for identifying AVP are retained to be used by TS29.229, so the newly defined AVP is allowed for using one of the AVP encoding to identify the AVP. In a data field of the AVP, each byte is used for representing the charging mode of the respective application server, that is, “00000000” represents on-line charging, “00000001” represents off-line charging, “00000010” represents that no limitation is made to the charging mode of the AS 15, “00000011˜1111111” are retained for future definition. The sequence of the AS 15 corresponding to the charging mode indication fields in the data fields of the AVP is the same as the sequence of appearance of the AS 15 in the user service information data represented by the XML format in the AVP “User-Data”, that is, the first charging mode indication field in the data fields of the AVP indicates the charging mode used by the application server represented by the first appeared “Application Server” class in the XML text of the “User-Data”, and the same rule applies to the rest, finally an alignment is achieved by using the 32^{nd} bit as the boundary. The sequence of appearance of AS 15 in the AVP “User-Data” should take into account of the AS 15 involved in turn in the iFC sets indicated by the example of the “Shared iFC Set” class.

By using this newly defined AVP, the message formats of the SAA and PPR commands of the Cx interface according to the present invention are as shown in FIG. 10 and FIG. 11, respectively, that is, an optional AVP “Application-Server-Charging-Type” is added after AVP “Charging-information”. Owing to the inherent extensibility of Diameter protocol, the embodiment also has good backward compatibility.

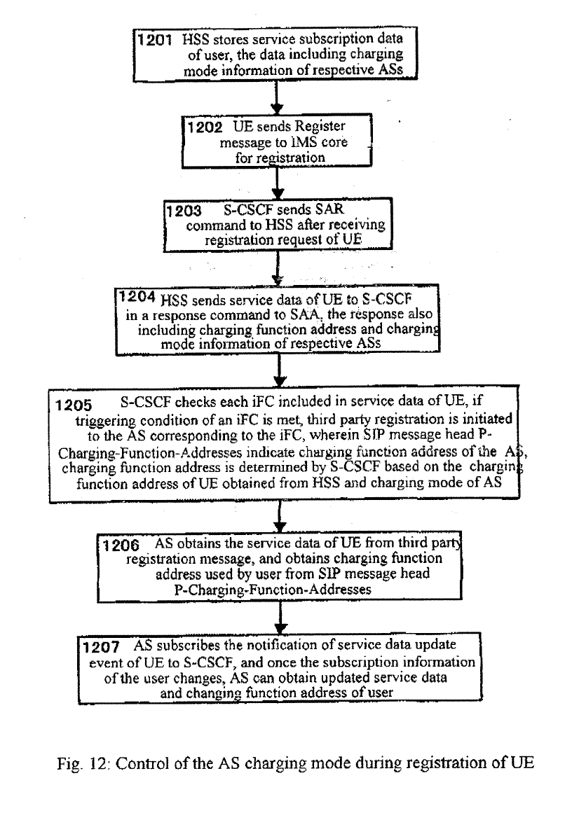

FIG. 12 shows a method of controlling the charging mode of AS 15 during the process of registration of UE 16 according to the present invention. The figure only shows the operations relevant to the control of the charging mode ins the present invention, and details of other operations and the relevant signaling process are consistent with 3GPP specifications TS24.228, TS24.229 and TS23.228. As shown in FIG. 12, in step 1201, after a user subscribed for the IMS service and the relevant applications HSS 14 is responsible for storing the service subscription data of user, wherein the data should include the charging mode information of respective ASs 15. In step 1202. UE 16 transmits SIP message “REGISTER” to IMS core for registration before using the services provided by the IMS network. In step 1203, S-CSCF 13 sends SAR command to HSS 14 after receiving the registration request of this UE 16. In step 1204, HSS 14 sends the service data of the UE 16 to S-CSCF 13 in a response command to SAA, the response also includes the charging function address and the charging mode information of the respective ASs 15. In step 1205, S-CSCF 13 checks each iFC included in the service data of the UE 16 according the priority. If the triggering condition of an iFC is met, a third party registration is initiated to the AS 15 corresponding to the iFC (according to TS29. 228, the condition of triggering a third party registration is that the trigger condition provided by the “Service Point Trigger” of the iFC includes at least the SIP method based on “REGISTER”), wherein SIP message head P-Charging-Function-Addresses indicate the charging function address of the AS 15, and this charging function address is determined by S-CSCF 13 based on the charging function address of the UE 16 obtained from HSS 14 and the charging mode of the AS 15. In step 1206, AS 15 obtains the service data of the UE 16 from the third party registration message from S-CSCF 13, which includes obtaining the charging function address used for the UE 16 from the SIP message head P-Charging-Function-Addresses of this message. In step 1207, AS 15 subscribes the notification of service data update event of the UE 16 to S-CSCF 13, and once the subscription information of the user changes, AS 15 car, obtain the updated information, such as the service data and changing function address of the UE 16.

According to the above description, after receiving the SIP session initial request or independent transactions request and the 1xx or 2xx responses to these requests, S-CSCF 13 would also make the charging function address of the AS 15 carried by the SIP message head P-Charging-Function-Addresses in the request and the response messages forwarded to the corresponding AS 15 (can be triggered by iFC), which charging function address is determined by S-CSCF 13 according to the charging function address of the UE 16 and the charging mode of the AS 15 obtained from HSS 14.

In the above-mentioned process, S-CSCF 13 determines the charging function address of the corresponding AS 15 by using the charging function address provided by AVP “Charging-Information” and the charging mode information of the respective AS 15 obtained through one of the previously described methods according to the following ways:

(1) When the charging function address provided by AVP “Charging-Information” includes at least one ECF and at least one CCF, the charging function address is selected according to the specified charging modes for the respective AS 15. Specifically, if a specified charging mode for an AS 15 is on-line charging, the charging function addresses sent to the AS 15 through the SIP message head P-Charging-Function-Addresses of ISC interface include all the ECF addresses provided by AVP “Charging-Information”, or include the at least one ECF and at least one CCF provided by AVP “Charging-Information”. (i.e. in the typical situation wherein the CGF 22 function has been built in OCS 24, generated CDR while performing real-time charging only requires including all the ECF addresses provided by ASP “Charging-Information”; while in the typical situation where the OCS 24 does not include CGF 22, generated CDR while performing real-time charging requires including at lest one ECF and at least one CCF provided by AVP “Charging-Information”) If the specified-charging mode for the AS 15 is off-line charging the charging function addresses sent to the AS 15 through the SIP message head P-Charging-Function-Addresses of ISC interface include all the CCF addresses provided by AVP “Charging-information”. If the charging mode for the AS 15 is not specified the charging function addresses, sent to the AS IS through the SIP message head P-Charging-Function-Addresses of ISC interface are all the addresses provided by AVP “Charging-Information”.

(2) When the charging function addresses provided by AVP “Charging-Information” include only CCF, no matter what the specified charging mode for the AS 15 is, the charging function addresses sent to the AS 15 through the SIP message head P-Charging-Function-Addresses of ISC interface are all the addresses provided by AVP “Charging-Information”.

As described previously, the existing Sh interface can support the mode of HSS 14 providing different charging function addresses to different AS 15 via Sh interface. According to the present invention, HSS 14 should have the function of controlling the charging mode of AS 15 through Sh interface, that is, when AS 15 inquires to HSS 14 the service subscription data of a user via Sh interface, HSS 14 can determine the charging function address for the AS 15 according to the charging mode information of the AS 15 included in the service data of the user stored in the HSS 14 and the charging function address concerned in the user service and based on the same principle as mentioned in the above method, and provide the user service data including the charging function address it used to the AS 15 via Sh interface. Thus since HSS 14 and S-CSCF 13 use the same method for determining the AS 15 charging function address, it would be ensured that the charging function addresses received by AS 15 from interfaces Cx and ISC is consistent with the charging function addresses received from the Sh interface.

It shall be noted that the above descriptions of the present invention in conjunction with the embodiments are only explanatory but not restrictive. Those skilled in the art can make different variations and improvement within the scope of the concept of the present invention. The scope of the present invention is defined by the appended claims. In addition, the word “comprising” does not exclude the presence of elements other than those listed in the description and claims, and the word “a” or “an” preceding an element does not exclude the presence of a plurality of such elements.

1. A method for configuring charging information in an Internet protocol multimedia sub-system which includes a home subscriber server, a service call state control function unit and an application server, characterized by comprising following steps:
storing charging mode information of the respective application servers involved in an user service in the home subscriber server;
sending charging function address information and the charging mode information to the service call state control function unit by the home subscriber server;
determining at the service call state control function unit, based on the received charging function address information and the charging mode information, the charging function addresses corresponding to the respective application servers, and forwarding the corresponding charging function address information to the respective application servers.

2. The method according to claim 1, wherein the step of storing charging mode information of the respective application server involved in an user service in the home subscriber server is performed by adding the charging mode information for the respective application servers to the data representing user subscription information.

3. The method according to claim 2, wherein an attribute of charging mode information is added to an “Application Server” class of the Unified Modeling Language model of the data representing the user subscription information, whose values include a value corresponding to the on-line charging mode and a value corresponding to the off-line charging mode.

4. The method according to claim 3, wherein the added attribute is “ChargingType” with the type of “enumerated”, whose values are “ONLINE-CHARGING” corresponding to the on-line charging mode, and “OFFLINE-CHARGING” corresponding to the value of the off-line charging mode.

5. The method according to claim 1, wherein the charging mode information is carried by an attribute value pair “User-Data” in the interface protocol between the home subscriber server and the service call state control function unit when it is transmitted from the home subscriber server to the service call state control function unit.

6. The method according to claim 5, wherein the charging mode information is included in user service information which is provided by the attribute value pair “User-Data” and described by the Extensible Markup Language.

7. The method according to claim 1, wherein an attribute value pair specifying the charging mode for the corresponding application server is added to the interface protocol between the home subscriber server and the service call state control function unit so as to transmit the charging mode information from the home subscriber server to the service call state control function unit.

8. The method according to claim 7, wherein a byte in the data field of the newly defined attribute value pair is corresponding to the charging mode for the application server, wherein “00000000” represents on-line charging and “000000011” represents off-line charging.

9. The method according to claim 8, wherein in the data field of the newly defined attribute value pair, the sequence of the application servers corresponding to each of the bytes is the same as the sequence of appearance of the application servers in the user service information data represented by the Extensible Markup Language in the attribute value pair “User-Data”.

10. The method according to claim 1, wherein the service call state control function unit determines the charging function addresses for respective application servers according to the received charging mode information for the respective application servers and the charging function address provided in the attribute value pair “Charging-Information”, and transmits the corresponding charging addresses to the respective application servers respectively.

11. The method according to claim 10, wherein when the charging function address provided in the received attribute value pair “Charging-Information” includes at least one ECF and at least one CCF, if the specified charging mode for an application server is on-line charging, the charging function addresses sent to the application server include at least all the ECF addresses provided by the attribute value pair “Charging-Information”; if the specified charging mode for the application server is off-line charging, the charging function addresses sent to the application server are all the CCF addresses provided by the attribute value pair “Charging-Information”; and if the charging mode for the application server is not specified, the charging function addresses sent to the application server are all the addresses provided by the attribute value pair “Charging-Information”.

12. The method according to claim 10, wherein when the charging function addresses provided by the attribute value pair “Charging-Information” include only CCF, the charging function addresses sent to the application server are all the addresses provided in the attribute value pair “Charging-Information”.

13. An Internet protocol multimedia sub-system in which the charging information can be flexibly configured, the Interne, protocol multimedia sub-system including a home subscriber server, a service call state control function unit, and an application server, characterized in that
the home subscriber server is adapted to store charging mode information of the application servers involved in an user service and for transmitting charging function address information and the charging mode information to the service call state control function unit;
the service call state control function unit is adapted to determine charging function address for respective application servers according to the received charging function address information and the charging mode information, and for forwarding corresponding charging function address information to the respective application servers, respectively.

14. The Internet protocol multimedia sub-system according to claim 13, wherein the data representing user subscription information stored in the home subscriber server includes the charging mode information for each of the application servers.

15. The Internet protocol multimedia sub-system according to claim 14, wherein an “Application Server” class of the Unified Modeling Language model of the data representing the user subscription information includes an attribute of the charging mode information, whose values include a value corresponding to the on-line charging mode and a value corresponding to the off-line charging mode.

16. The Internet protocol multimedia sub-system according to claim 15, wherein the attribute of the charging mode information is an attribute “ChargingType” with the type of “enumerated”, whose values are “ONLINE-CHARGING” corresponding to the on-line charging mode, and “OFFLINE-CHARGING” corresponding to the value of the off-line charging mode.

17. The Internet protocol multimedia sub-system according to claim 13, wherein the charging mode information is carried by an attribute value pair “User-Data” in the interface protocol between the home subscriber server and the service call state control function unit when it is transmitted from the home subscriber server to the service call state control function unit.

18. The Internet protocol multimedia sub-system according to claim 17, wherein the charging mode information is included in user service information which is provided by the attribute value pair “User-Data” and described by the Extensible Markup Language.

19. The Internet protocol multimedia sub-system according to claim 13, wherein the interface protocol between the home subscriber server and the service call state control function unit includes an attribute value pair for specifying the charging mode for the corresponding application server to transmit the charging mode information from the home subscriber server to the service call state control function unit.

20. The Internet protocol multimedia sub-system according to claim 19, wherein a byte in the data field of the attribute value pair is corresponding to the charging mode for the application server, wherein “00000000” represents on-line charging, and “00000001” represents off-line charging.

21. The Internet protocol multimedia sub-system according to claim 20, wherein in the data field of the attribute value pair, the sequence of the application servers corresponding to each of the bytes is the same as the sequence of appearance of the application servers in the user service information data represented by the Extensible Markup Language in the attribute value pair “User-Data”.

22. The Internet protocol multimedia sub-system according to claim 13, wherein the service call state control function unit is configured to 13, wherein the charging function addresses for respective application servers according to the received charging mode information for the respective application servers and the charging function address provided in the attribute value pair “Charging-information”, and to transmit the corresponding charging addresses to the respective application servers, respectively.

23. The Internet protocol multimedia sub-system according to claim 22, wherein when the charging function address provided in the attribute value pair “Charging-Information” received by the service call state control function unit includes at least one ECF and at least one CCF, if the specified charging mode for an application server is on-line charging, the charging function addresses sent by the service call state control function unit to the application server include at least all the ECF addresses provided by the attribute value pair “Charging-Information”; if the specified charging mode for the application server is off-line charging, the charging function addresses sent by the service call state control function unit to the application server are all the CCF addresses provided by the attribute value pair “Charging-Information”; and if the charging mode for the application server is not specified, the charging function addresses sent by the service call state control function unit to the application server are all the addresses provided by the attribute value pair “Charging-Information”.

24. The Internet protocol multimedia sub-system according to claim 22, wherein when the charging function addresses provided by the attribute value pair Charging-Information include only CCF, the charging function addresses sent to the application server are all the addresses provided in the attribute value pair “Charging-Information”.
